(19) United States
(12) Patent Application Publication
(10) Pub. No.: US 2024/0083262 A1
(43) Pub. Date: Mar. 14, 2024

(54) FUEL-CELL SYSTEM FOR DRIVING A VEHICLE

(71) Applicant: ZF CV Systems Global GmbH, Bern (CH)

(72) Inventor: Janik Ricke, Uetze (DE)

(21) Appl. No.: 18/511,703

(22) Filed: Nov. 16, 2023

Related U.S. Application Data
(63) Continuation of application No. PCT/EP2022/062870, filed on May 12, 2022.

(30) Foreign Application Priority Data
May 28, 2021 (DE) 10 2021 113 910.4

(51) Int. Cl. B60L 50/51; B60L 58/31; H01M 8/04746

(52) U.S. Cl. CPC B60L 50/51; B60L 58/31; H01M 8/04776

(57) ABSTRACT

A fuel cell system for propulsion of a vehicle includes a compressor for supplying air to the cathode side of a fuel cell. The compressor has an electric motor, a rotor shaft operatively connected to the motor in order to be driven in rotation thereby. A bearing arrangement supports the rotor shaft rotatably and has an air bearing with a bearing gap. The bearing supports the rotor shaft in the compressor. An encircling air gap forms when a lift-off speed of the rotor shaft is reached/overshot. The compressor has a flow path opening into the bearing gap. The system has an actuatable shut-off element arranged in the flow path between a compressed-air supply and the bearing gap and which is configured to selectively close/open the flow path. A controller is configured to open/close the shut-off element and actuate the electric motor in a mutually dependent manner.

### CROSS-REFERENCE TO RELATED APPLICATIONS

This application is a continuation application of international patent application PCT/EP2022/062870, filed May 12, 2022, designating the United States and claiming priority from German application 10 2021 113 910.4, filed May 28, 2021, and the entire content of both applications is incorporated herein by reference.

### TECHNICAL FIELD

The present disclosure relates to a fuel cell system for the propulsion of a vehicle, in particular of a utility vehicle, having a compressor, in particular a turbo compressor, for supplying air to the cathode side of a fuel cell, wherein the compressor has an electric motor, a rotor shaft that is operatively connected to the electric motor in order to be driven in rotation via the electric motor, and a bearing arrangement that supports the rotor shaft rotatably in the compressor, wherein the bearing arrangement has at least one air bearing which has a bearing gap and which supports the rotor shaft in the compressor with a gap and which is configured to form an encircling air gap when a predetermined lift-off rotational speed of the rotor shaft is reached or overshot.

### BACKGROUND

As part of the ongoing mobility transition, alternative forms of propulsion are gaining in importance, in particular in the utility vehicle industry. Here, fuel cell systems play a prominent role. In hydrogen-powered fuel cell systems, it is necessary for oxygen, normally in the form of pressurized air, to be fed to a cathode side of the fuel cell. Fuel cell systems are known in which the supply of air on the cathode side is performed by a compressor, in particular a turbo compressor. The compressors that are normally used have a rotor shaft that is driven by electric motor. The rotor shafts in the compressors of such systems reach very high rotational speeds, and the support of the rotor shafts is therefore of central importance.

Air bearing arrangements with aerodynamic air bearings have become established, which, when they reach their bearing-specific lift-off rotational speed, form a constant encircling air gap and thus automatically assume a floating state. The advantage of such air bearing arrangements is extremely low friction above the lift-off rotational speed.

At the same time, however, the air bearings are among the most sensitive parts of a compressor in fuel cell systems. If the rotating parts, preferably the rotor shaft or rotating parts connected thereto, for example rotating bearing shells, make contact with static parts, for example static bearing shells, during operation, sliding friction and thus wear occur, for example in the bearings. Since, in extreme situations, the optimum supply of air to the fuel cell can no longer be ensured in the case of worn bearings, the bearings must be exchanged or undergo maintenance in a timely manner, such that the life expectancy of a bearing is a determining factor for the length of the maintenance intervals of the compressor and thus of the fuel cell systems. Known fuel cell systems use bearings with a service life of approximately 8000 to 9000 operating hours.

### SUMMARY

The disclosure was consequently based on the object of overcoming the above-described challenges as far as possible. In particular, it was the object of the disclosure to specify a fuel cell system of the type mentioned in the introduction, in the case of which the maintenance intervals can be lengthened. Furthermore, the disclosure was based in particular on the object of improving the longevity of the bearings in such systems.

In the case of a fuel cell system of the type mentioned in the introduction, the disclosure achieves the object on which it is based in that the compressor has an air bearing flow path, in particular for compressed air, which opens into the bearing gap and which has an interface for fluidically connecting to a compressed-air supply of the vehicle, and the fuel cell system furthermore has an actuatable shut-off element, which is arranged in the air bearing flow path between the compressed-air supply and the bearing gap and which is configured to selectively close and open the air bearing flow path, and in that the fuel cell system has a control unit which is signal-transmittingly connected to the electric motor for the purposes of actuating same and to the shut-off element and which is configured to open and close the shut-off element, and actuate the electric motor, in a mutually dependent manner.

According to the disclosure, the actuation of the electric motor is to be understood to mean that the electric motor is intended to take place both directly and indirectly with the cooperation and/or interposition of further components, for example a power electronics unit, in a generally known manner, wherein individual, several or all of the components of such a power electronics unit may be dedicated components or components that are integrated into the electric motor or compressor. This is also to be regarded as including the use of the required signal-transmitting means, via which the power electronics unit, the electric motor and the control unit communicate.

Here, the disclosure follows the basic approach of being able to switch the operating state of the electric motor in a manner dependent on the existence of compressed-air support in the bearing gap, and conversely activate or deactivate the compressed-air support in a manner dependent on the operating state of the electric motor. The rotational speed of the rotor shaft is a relevant control parameter that represents the operating state of the electric motor. In other words, in this context, the disclosure proposes that the bearing arrangement be supported, by additionally injecting pressurized air into the bearing gap via the air bearing flow path, when it is intended to actuate the electric motor. By additionally injecting compressed air into the bearing gap, the friction force acting between the components, and thus also the wear, are reduced. It is optimal for such a quantity of compressed air to be conveyed through the flow path into the bearing gap that a lift-off of the rotor shaft is achieved before the rotor shaft has actually reached its bearing-specific lift-off rotational speed. By virtue of a functional relationship being established between the opening of the shut-off element for the purposes of injecting pressurized air into the bearing gap and the time at which the electric motor is actuated, pressurized air can be injected into the bearing gap very specifically at those times at which, owing to the rotational speed, the otherwise expected bearing wear is at its greatest, namely during the start-up of the compressor from a standstill and during the stoppage of the compressor to a standstill, in particular when the rotational speed of the rotor shaft falls below the lift-off rotational speed. The service life of air bearings can be more than doubled using this measure.

In a first embodiment of the disclosure, the bearing arrangement has two or more air bearings which each have a bearing gap with an associated air bearing flow path inlet and shut-off element inlet. Dedicated shut-off elements, or one common shut-off element for all flow paths, may be used.

The lift-off rotational speed of the one or more air bearings may be determined experimentally or computationally for each bearing in conjunction with the relevant rotating mass, that is, of the rotor shaft, and stored in the control unit.

A multi-way valve, for example a 2/2 directional valve, which is actuatable via the control unit by wire or wirelessly and which is signal-transmittingly connected to the control unit for this purpose, is preferably provided as a shut-off element.

According to the disclosure, the control unit may be a dedicated control unit or may be a module that is implemented in software or hardware form in the control unit of the compressor. Alternatively or in addition, the control unit may be a module that is implemented in software or hardware form in the fuel cell controller. Further alternatively or in addition, the control unit may be integrated in hardware or software form into a brake control unit of the vehicle, in particular a trailer or tractor vehicle brake control unit, or may be configured as such a unit.

In an embodiment, the control unit is configured to actuate the electric motor, in order to drive the rotor shaft when a commencement of drive is desired, simultaneously with an opening of the shut-off element. This form of control is very simple to implement in terms of circuitry or programming, and, upon every activation operation that causes electric motor to start, ensures additional support of the air bearings via compressed air that is injected into the bearing gap.

In an alternative embodiment, the control unit is configured to firstly open the shut-off element, in order to convey pressurized air into the bearing gap, and only subsequently actuate the electric motor, in order to drive the rotor shaft, when a commencement of drive of the rotor shaft is desired. In this embodiment, the injection of the air has the effect that the weight force acting on the contact point between the rotating parts, preferably the rotor shaft or shaft-side bearing shells or counterparts, and static parts, such as housing-side bearing shells or counterparts, is supported already before the electric motor initiates a rotation of the rotor shaft. It is particularly preferable for air to be injected into the bearing gap in a quantity sufficient to cause the rotor shaft to already lift off. For this purpose, it may be advantageous for pressurized air to be injected into the bearing gap from multiple peripherally distributed inlet openings.

In a further embodiment, the control unit is configured to actuate the electric motor only after a predetermined duration has elapsed following the opening of the shut-off element, the duration preferably representing a time required before an initial lift-off of the rotor shaft is to be expected owing to the introduced or injected compressed air. The duration that elapses before the rotor shaft lifts off for the first time owing exclusively to the injection of pressurized air may be ascertained empirically in preliminary tests and stored as a control parameter in the control unit.

In a further embodiment, the air bearing flow path is assigned a mass flow sensor, and the control unit is signal-transmittingly connected to the mass flow sensor and is configured to actuate the electric motor only after a predetermined quantity of compressed air has been conveyed into the bearing gap, wherein the predetermined quantity of compressed air preferably represents a compressed-air quantity required before an initial lift-off of the rotor shaft occurs. As an alternative to the above-described empirical ascertainment of a duration before the initial lift-off occurs, and furthermore also in addition to this, a mass flow sensor may be used to empirically ascertain the air quantity that is injected into the air gap before an initial lift-off can be observed.

As an alternative or in addition to the mass flow sensor, it is preferable for the air bearing flow path to be assigned a pressure sensor, and for the control unit to be signal-transmittingly connected to the pressure sensor and to be configured to actuate the electric motor only after a predetermined pressure, a so-called supporting pressure, has been reached, wherein the predetermined pressure represents a pressure that is required in the bearing gap in order for the rotor shaft to lift off. The supporting pressure preferably lies in a range of 4 bar or higher, more preferably 6 bar or higher, particularly preferably 8 bar or higher.

The mass flow and/or pressure sensor is preferably arranged in each case either in the part of the air bearing flow path that is within the housing or in the air bearing flow path upstream of the compressor housing, for example at the interface for connecting to the compressed-air supply, or in the compressed-air supply.

In a further embodiment, a rotating part, preferably the rotor shaft or a shaft-side bearing shell of the air bearing, and a static part of the compressor, preferably a housing-side bearing shell of the air bearing, are operatively connected to a contact sensor that is configured to identify a lift-off of the rotating part from the static part, and the control unit is signal-transmittingly connected to the contact sensor and is configured to actuate the electric motor, in order to drive the rotor shaft, only after the contact sensor has identified a lift-off of the rotating part. There is preferably electrical contact between the rotating part, which interacts with the rotor shaft, and the static part, the electrical contact being interrupted when lift-off occurs, or a capacitance or resistance that changes when lift-off occurs. The contact sensor is correspondingly preferably configured to detect a change in the relevant electrical variable, and may for example signal a lift-off to the control unit when the electrical current flowing via the contact falls below a threshold value, or the voltage or capacitance exceeds particular threshold values.

Alternatively or in addition, the fuel cell system has a measuring unit for detecting changes in field strength in the field of the electric motor, wherein the measuring unit is signal-transmittingly connected to the control unit and the control unit is configured to use the transmitted signals to identify a lift-off of the rotor shaft on the basis of the change in field strength. In the electric motor, the rotor shaft acts as an electromagnetic core, and the change in the position of the rotor shaft causes a detectable change in field strength.

In a further embodiment, the control unit is configured to close the shut-off element again, after the start of the actuation of the electric motor for the purposes of driving the rotor shaft, only when the rotor shaft has reached or overshot the lift-off rotational speed. Preferably, the electric motor is operatively connected to a power electronics unit and is actuated via the power electronics unit. The power electronics unit preferably includes an inverter. The operating information of the power electronics unit can be read out, and from this the rotational speed of the rotor shaft can be ascertained in a generally known manner.

In this embodiment, no further additional compressed air is injected into the bearing gap after the lift-off rotational speed has been reached, because, beyond the lift-off rotational speed, the air bearing is independently capable of forming an encircling air gap and of holding the shaft in a floating state. The compressed-air supply of the vehicle is thus relieved of load.

In a further embodiment, the control unit is configured to open the shut-off element when a stoppage of drive of the electric motor is desired, that is, proceeding from a state of operation, before the lift-off rotational speed is undershot, preferably exactly when the lift-off rotational speed is reached. The same wear-reducing effect that can be achieved when the electric motor is started is also achieved when the operation of the compressor is ended, by virtue of the additional air support via the compressed-air flow path into the bearing gap being activated again when the rotational speed of the rotor shaft decreases and the lift-off rotational speed is approached, this time from above, that is, proceeding from a range of higher rotational speeds. When the lift-off rotational speed is reached, before the rotating parts on the rotor shaft can come into contact with the static parts of the compressor again, the air cushion formed in the bearing gap by the additionally injected air takes over the task of providing support, and allows continued braking of the rotor shaft without wear.

In a further embodiment, the control unit is configured to close the shut-off element only when the rotational speed of the rotor shaft lies in a range below 500 rpm, preferably below 200 rpm, more preferably below 100 rpm, particularly preferably below 50 rpm, and is in particular 0.

The longer the supporting action of the additionally injected air is maintained in this phase, the less wear occurs.

In an embodiment, the air bearing is an axial bearing or a radial bearing. The bearing arrangement furthermore preferably has both one or more axial air bearings and one or more radial air bearings, wherein one, several or all of the air bearings preferably each have one, or one common, bearing gap that is fluidically connected to the air bearing flow path.

The air bearing is preferably an aerostatic bearing, and the bearing arrangement furthermore preferably has at least one aerodynamic bearing, which is preferably configured as a foil bearing, for example leaf-type or bump-type foil bearing, or as a spiral groove bearing, for example radial or axial spiral groove bearing. The aerodynamic bearing, or preferably the multiple aerodynamic bearings, is or are preferably arranged adjacent to the aerostatic bearing. In embodiments, the aerostatic bearing and the aerodynamic bearing share the bearing gap.

In further embodiments, the bearing arrangement has at least two aerostatic bearings and at least two aerodynamic bearings.

In a further embodiment, the air bearing flow path is assigned a filter, in particular an oil filter and/or a particle filter. The oil filter and/or the particle filter are preferably arranged in the flow path between the interface for the compressed-air supply and the bearing gap, or upstream of the interface between the interface and the compressed-air supply, preferably upstream of the shut-off element. For the use of this filter, the risk of the air for the air bearing contaminating the compressed air that is to be fed by the compressor to the cathode side of the fuel cell is further reduced.

In an alternative embodiment, the compressed-air supply, for example for a brake system of the vehicle, already has one or more filters, such that the compressed air that is fed to the air bearing flow path has already been filtered. The air bearing flow path is then preferably configured without a filter.

The disclosure has been described above in a first aspect with reference to the fuel cell system according to the disclosure. In a second aspect, the disclosure relates to a vehicle, in particular a utility vehicle, having a fuel cell system for the propulsion of the vehicle, and having a compressed-air supply that is configured to provide pressurized air for pneumatic consumers of the vehicle.

The disclosure achieves the object on which it is based by proposing that the fuel cell system is configured according to any one of the embodiments described above, and the air bearing flow path is fluidically connected to the compressed-air supply such that pressurized air flows into the bearing gap when the shut-off element is open.

In a second aspect, the disclosure utilizes the same advantages and embodiments as the fuel cell system according to the first aspect, for which reason reference is made to the above statements in order to avoid repetitions.

In an embodiment, the compressed-air supply of the vehicle is configured to supply compressed air to several compressed-air circuits of the vehicle, and the air bearing flow path is fluidically connected to one of the compressed-air circuits.

The disclosure utilizes the fact that the vehicle has a compressor and an air treatment device in its compressed-air supply in any case, for example for the purposes of providing a supply to the vehicle brake and optionally further systems such as an air suspension system, a transmission et cetera. The air bearing flow path utilizes synergistic effects by obtaining the required compressed air via one of the compressed-air circuits.

The various compressed-air circuits of the vehicle commonly differ in terms of their safety relevance and in terms of the nature of the components which are to be actuated and to which a supply is to be provided. For example, safety-relevant compressed-air circuits control the braking functions or assist the vehicle or the gearshift operations of the vehicle. Non-safety-relevant compressed-air circuits serve for supplying compressed air to so-called secondary consumers.

Other compressed-air circuits in turn serve for supplying compressed air to vehicle trailers (trailer supply), if present. Preferably, the air bearing flow path is fluidically connected to a compressed-air circuit for non-safety-relevant secondary consumers.

In a further aspect, the disclosure relates to a method for operating a fuel cell system of a vehicle, in particular of a utility vehicle, wherein the fuel cell system is configured in particular according to any one of the above-described embodiments. The proposed method includes the steps:
transmission of a start command to a control unit when a commencement of drive is desired; and mutually dependent
opening of the shut-off element in the air bearing flow path of the compressor via the control unit such that pressurized air is conveyed from the compressed-air supply into the bearing gap, and
actuation of the electric motor in order to drive the rotor shaft, in particular via the control unit.

The method utilizes the same advantages and embodiments as the fuel cell system and the vehicle of the two aspects described above, for which reason reference is made in turn to the above statements in order to avoid repetitions.

The method is advantageously refined by including one, several or all of the following steps:
simultaneous actuation of the electric motor in order to drive the rotor shaft and opening of the shut-off element in order to convey compressed air into the bearing gap, or initial opening of the shut-off element and only subsequent actuation of the electric motor in order to drive the rotor shaft;
actuation of the electric motor only after a predetermined duration has elapsed following the opening of the shut-off element, wherein the duration preferably represents a time required before an initial lift-off of the rotor shaft is to be expected;
detection of the mass flow conveyed through the air bearing flow path, and actuation of the electric motor only after a predetermined quantity of compressed air has been conveyed into the bearing gap, wherein the predetermined quantity of compressed air preferably represents a compressed-air quantity required before an initial lift-off of the rotor shaft occurs;
detection of the pressure prevailing in the air bearing flow path, and actuation of the electric motor only after a predetermined pressure has been reached, wherein the predetermined pressure preferably represents a pressure required before the initial lift-off of the rotor shaft occurs;
identification of the lift-off of a rotating part from a static part of the compressor, and actuation of the electric motor only after the lift-off of the rotating part has been identified;
closure of the shut-off element again, after the start of the actuation of the electric motor, only when the rotor shaft has reached or overshot the lift-off rotational speed;
opening of the shut-off element, when a stoppage of drive of the electric motor is desired, before the lift-off rotational speed is undershot, preferably when the lift-off rotational speed has been reached; and/or
closure of the shut-off element only when the rotational speed of the rotor shaft lies in a range below 500 rpm, preferably below 200 rpm, more preferably below 100 rpm, particularly preferably below 50 rpm, and is in particular 0.

In a further aspect, the disclosure relates to a control unit for a fuel cell system of a vehicle, in particular of a fuel cell system according to any one of the above-described embodiments. The control unit may be a dedicated control unit for a compressor, or a control unit for the fuel cell, or a stand-alone control unit. The control unit may be implemented in hardware or software form, as a module, into other control units, for example in a brake control unit, in particular trailer or tractor vehicle brake control unit, a compressor control unit, or the fuel cell controller. In other words, the control unit may also be configured as such an abovementioned unit. The control unit is configured to carry out the method according to any one of the above-described embodiments, and for this purpose has for example a data memory, in which commands for carrying out the method of the above-described embodiments are stored, and a processor, which is configured to carry out the method according to any one of the above-described embodiments via the commands stored in the data memory. The advantages and embodiments of the fuel cell system, of the vehicle and of the method are at the same time advantages and embodiments of the control unit according to the disclosure and vice versa, for which reason reference is made in turn to the above statements in order to avoid repetitions.

Finally, in a further aspect, the disclosure relates to a computer program product. In this regard, the disclosure achieves the object mentioned in the introduction by virtue of the computer program product including commands which, when executed on a computer, cause the computer to form a control unit according to any one of the above-described embodiments and/or to carry out the method according to any one of the above-described embodiments. The computer program product may be present on a computer-readable medium or in downloadable form.

### BRIEF DESCRIPTION OF DRAWINGS

The invention will now be described with reference to the drawings wherein:

FIG. 1 is a schematic illustration of a fuel cell system according to an embodiment; and.

FIG. 2 is a schematic illustration of a method for operating a fuel cell system according to an embodiment.

### DETAILED DESCRIPTION

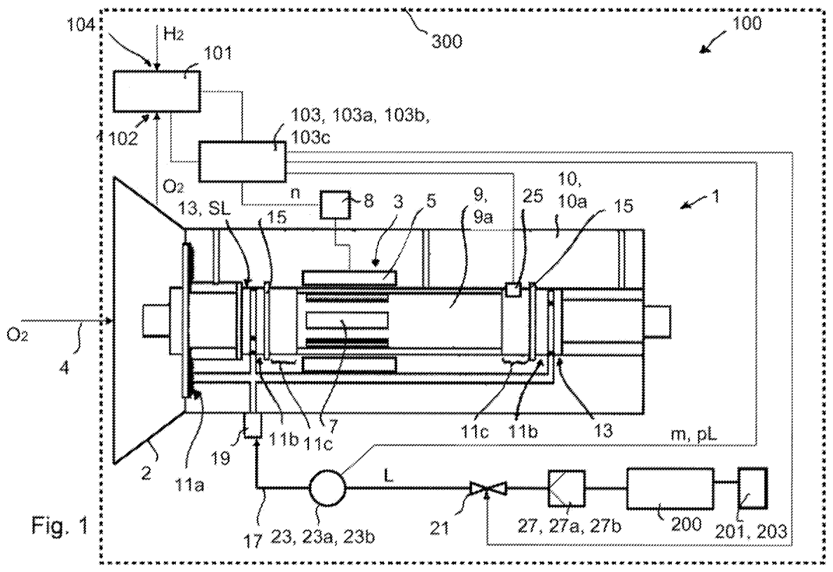

FIG. 1 illustrates a fuel cell system 100. For better clarity, only the components that are relevant for the disclosure and for comprehension thereof are illustrated. It should be understood that the fuel cell system may require, and generally has, various further components in order to function in the proper manner. The fuel cell system 100 shown here functions substantially in the same way as previously known fuel cell systems, with the exception of the aspects of the disclosure highlighted here.

The fuel cell system 100 has a fuel cell 101. The fuel cell 101 has a cathode-side oxygen feed 102 and an anode-side hydrogen feed 104. The anode-side hydrogen feed 104 is fluidically connected (in a manner that is not illustrated) to a hydrogen supply. The cathode-side oxygen feed 102 is fluidically connected to a compressor 1. The compressor 1 shown in FIG. 1 has at least one compressor stage 2. The compressor 1 may be configured as a multi-stage compressor, but the explanation of only one compressor stage is sufficient for comprehension of the disclosure.

The compressor stage 2 is fluidically connected to an oxygen feed 4 and is configured to compress a gas or substance mixture, normally air, which is fed thereto, and to discharge same at elevated pressure in the direction of the fuel cell 101.

To operate the compressor stage 2, the compressor 1 has an electric motor 3 having a stator 5 and a rotor 7. The rotor 7 is coupled to a rotor shaft 9, which is driven in rotation by the electric motor 3. The electric motor 3 is provided for actuation via a power electronics unit 8, for example.

The rotor shaft 9 is supported rotatably in a compressor housing 10 via a bearing arrangement 11, wherein the bearing arrangement 11 has at least one aerodynamic-aerostatic axial bearing 11a and two aerostatic radial air bearings 11b. The bearing arrangement 11 furthermore has two aerodynamic radial air bearings 11c.

At least the radial air bearings 11b, 11c each have a bearing gap 13 which, when the rotor shaft 9 is at a standstill, is not of fully encircling form but is interrupted at least at certain points as a result of the rotor shaft 9, or bearing shells correspondingly arranged on the rotor shaft, lying against respectively corresponding parts of the air bearings 11a, b, c. The aerostatic radial air bearings 11b and the aerodynamic radial air bearings 11c are mutually spaced in each case via a thrust collar 15 with ventilation openings.

An air bearing flow path 17 opens into each of the bearing gaps 13 and is fluidically connectable, via an interface 19 arranged on the compressor housing 10, to a compressed-air supply 200 for providing pressurized air L to the air bearing flow path. The compressed-air supply 200 may be a dedicated compressed-air supply having a pressure store and/or a compressor (neither of which is illustrated). The compressed-air supply 200 is particularly preferably integrated into a compressed-air supply system of the vehicle 300, for example having a dedicated compressor (not illustrated) and a dedicated air treatment device (not illustrated). The compressed-air supply system is configured for example to provide a supply to the vehicle brake and optionally further systems such as an air suspension system, a transmission, et cetera, and for this purpose has one or more compressed-air circuits 201. The fuel cell system can thus for example extract pressurized air L from a compressed-air circuit 203 for non-safety-relevant secondary consumers. In this regard, reference is made to the statements made above in the general part.

The air bearing flow path 17 has, upstream of the interface 19, a filter 27 which may for example be an oil filter 27a or a particle filter 27b (hereinafter summarized as 27). It is ensured via the filter 27 that technically pure air, in particular oil-free air, can pass into the compressor 1, but contaminants and impurities, in particular oil, are prevented from entering the compressor 1.

It is furthermore preferable for a shut-off element 21 to be arranged in the air bearing flow path 17, in the embodiment between the interface 19 and the filter 27. The shut-off element 21 is configured to be switched back and forth selectively between an open position and a closed position, wherein a fluid flow through the air bearing flow path 17 into the bearing gaps 13 is prevented in the closed position and is enabled in the open position.

Furthermore, a sensor 23 is preferably arranged in the air bearing flow path 17. The sensor 23 may be configured for example as a mass flow sensor 23a for detecting a mass flow m, or as a pressure sensor 23b for detecting a pressure p_{L}.

The fuel cell system 100 has a control unit 103. The control unit 103 may be a dedicated control unit or a (part of a) brake control unit 103a, compressor control unit 103b or fuel cell controller 103c. In this respect, reference is made in turn to the statements made above in the general part, and the reference designation 103 will hereinafter be used collectively.

The compressor 1 has a contact sensor 25, which in the embodiment shown is formed on a part 9a, for example of one of the aerodynamic radial air bearings 11c, which rotates with the rotor shaft 9, in order to monitor the lift-off of the rotating part 9a that moves with the rotor shaft 9, for example a bearing inner shell, from a housing-side static part 10a, for example a bearing outer shell. The contact sensor 25 is preferably configured as described above in the general part.

In the present embodiment, the control unit 103 is signal-transmittingly connected to the fuel cell 101 in order to actuate the compressor 1 as required in order to feed oxygen to the cathode side of the fuel cell 101.

The control unit 103 is signal-transmittingly connected to the electric motor 3, for example via the power electronics unit 8, and is configured to actuate the electric motor 3 in order to drive the rotor shaft 9 for the purposes of achieving a level of compression power of the compressor stage 2 that is required by the fuel cell 101. The power electronics unit 8 preferably includes an inverter.

The control unit 103 is furthermore signal-transmittingly connected to the shut-off element 21 and is configured to open and close the shut-off element 21 in a manner dependent on the actuation of the electric motor 3.

The control unit 103 is furthermore signal-transmittingly connected to the sensor 23 and configured to receive and process signals from the sensor 23, which signals represent the existence of an activation condition for the electric motor 3. If the sensor 23 is configured as a mass flow sensor, the activation condition is expediently the conveyance of a predetermined quantity of air into the bearing gaps 13. If a pressure sensor is used, the activation condition is correspondingly the attainment of a predetermined pressure.

Alternatively or in addition, if the contact sensor 25 is present, the control unit 103 is signal-transmittingly connected to the contact sensor 25 and is configured to receive and process signals from the contact sensor 25, which signals represent whether the rotor shaft 9 is still lying on, or has lifted off from, the corresponding bearing shells, this being monitored by the contact sensor 25. This signal, too, represents the existence of an activation condition for the electric motor 3.

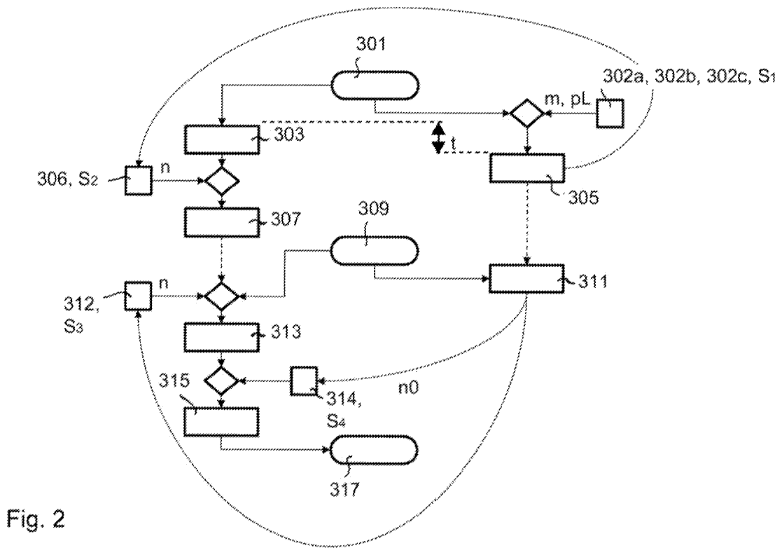

The functioning of the fuel cell system 100 will be described in more detail below, with reference also to FIG. 2.

Firstly, in a step 301, a start command is issued which represents a desire to start the feed of oxygen to the cathode side of the fuel cell 101, that is, represents that a commencement of drive of the compressor 1 is desired.

The control unit 103 actuates the shut-off element 21 in order, in step 303, to initiate the conveyance of compressed air into the bearing gaps 13.

In a step 305, either simultaneously with step 303 or subsequently to step 303, the control unit 103 actuates the electric motor 3, preferably via the power electronics unit 8, to set the rotor shaft 9 in rotation in order, in the compressor stage 2, to compress the air that enters via the feed 4. The actuation of the electric motor 3 is dependent on whether or not an activation condition S1 is met. An activation condition S1 may for example be a predetermined duration t after the opening of the shut-off element 21 in step 303, the duration being stored in the control unit 103, or a representative mass flow signal detected in a step 302a, and/or a pressure signal detected in a step 302b, or a contact (interruption) signal detected in a step 302c, and the signaling thereof by one of the sensors 23, 25 in each case to the control unit 103 to the effect that the rotor shaft 9 can then be safely started, because it can be assumed that the rotor shaft 9 has assumed a floating state. The rotor shaft 9 is driven by the electric motor 3 and rotates at progressively higher speed until a rotational speed n₀, which is dependent on the control unit 103, is reached.

Then, in step 307, the control unit 103 actuates the shut-off element 21 again and moves this into the closure position. The assumption of the closure position in step 307 is dependent on whether a closure criterion S2 is met. A closure criterion S2 may for example be a signal relating to the rotational speed n₀, in particular lift-off rotational speed n, the signal being detected from the electric motor 3, or from the power electronics unit 8 coupled to the electric motor 3, in a step 306 and being transmitted to the control unit 103. For example, if a lift-off rotational speed n stored in the control unit 103 has been reached, then in the step 307, the compressed-air feed in the air bearing flow path 17 can be safely shut off by closing the shut-off element 21, because an encircling air gap S_{L} has formed in the bearing gap 13 and the aerodynamic air bearings 11c can hold the rotor shaft 9 in a floating state without the need for additional air L to be fed in.

The compressor 1 can now be stably operated. No significant wear occurs to the aerodynamic bearings 11c or the aerostatic bearings 11a, b.

If it is intended to end the operation of the compressor 1, then in step 309 a deactivation command is issued, whereupon, in step 311, the electric motor 3 is correspondingly actuated in order to reduce its rotational speed n₀ to a standstill. As the rotational speed of the rotor shaft 9 of the compressor 1 thus steadily decreases proceeding from step 311, the control unit 103 actuates the shut-off element 21 again in step 313 in order to move it into the open position and convey air into the bearing gaps 13 again. The opening of the shut-off element 21 is dependent on whether an opening-up criterion S3 is met. For example, the opening-up criterion S3 may exist if a signal representing that the motor rotational speed or the rotational speed n₀ of the rotor shaft 9 is approaching or has reached the lift-off rotational speed n is detected from the electric motor 3 or the power electronics unit 8, and is output, in a step 312. As a result of the air bearing flow path 17 being opened up again by virtue of the shut-off element 21 being opened, it is made possible for the rotor shaft 9 to be supported before it can set down, and generate wear, when the lift-off rotational speed n is undershot.

The rotational speed of the rotor shaft 9 can then be reduced further toward a standstill without further damage or wear being caused to the bearings. It is thus finally possible, in a step 315, for the shut-off element 21 to be actuated by the control unit 103 again and moved into the closed position. The closure of the shut-off element 21 again is dependent on whether a closure criterion S4 is met. For example, the closure criterion S4 exists if, in a step 314, a signal representing that the rotational speed n₀ of the rotor shaft 9 has fallen below a critical rotational speed, below which wear does not occur or scarcely occurs even in the event of contact between the rotating and static parts 9a, 10a, is detected from the electric motor 3 or from the power electronics unit 8 and is transmitted to the control unit 103.

The control sequence is thereafter ended in step 317.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (PART OF THE DESCRIPTION)

1 Compressor
2 Compressor stage
3 Electric motor
4 Oxygen feed
5 Stator
7 Rotor
8 Power electronics unit
9 Rotor shaft
9a Rotating part
10 Compressor housing
10a Static part
11 Bearing arrangement
11a Aerostatic axial bearing
11b Aerostatic radial air bearing
11c Aerodynamic radial air bearing
13 Bearing gap
15 Thrust collar
17 Air bearing flow path
19 Interface
21 Shut-off element
23 Sensor
23a Mass flow sensor
23b Pressure sensor
25 Contact sensor
27 Filter
27a Oil filter
27b Particle filter
100 Fuel cell system
101 Fuel cell
102 Cathode-side oxygen feed
103 Control unit:
103a Compressor control unit
103b Brake control unit
103c Fuel cell control unit
104 Anode-side hydrogen feed
200 Compressed-air supply
201 Compressed-air circuit
203 Compressed-air circuit for non-safety-relevant secondary consumers
300 Vehicle
301-317 Steps of the method
301 Transmission of a start command when a commencement of drive is desired
302 Detection of an activation condition
302a in the form of a mass flow
302b in the form of a pressure
302c in the form of an interruption of contact
303, 313 Opening of the shut-off element
305 Actuation of the electric motor, start
306 Detection of a closure criterion
309 Desired stoppage of drive
307, 315 Closure of the shut-off element
311 Actuation of the electric motor, end
312 Detection of an opening-up criterion
317 End
n₀ Rotational speed
n Lift-off rotational speed
m Mass flow
p_{L} Pressure
S_{L} Air gap
t Predetermined duration
L Air
S1 Activation condition
S2 Closure criterion
S3 Opening-up criterion
S4 Closure criterion

1. A fuel cell system for the propulsion of a vehicle, the fuel cell system comprising:
a compressor configured to supply air to a cathode side of a fuel cell, wherein said compressor has an electric motor, a rotor shaft operatively connected to said electric motor in order to be driven in rotation via said electric motor, and a bearing arrangement that supports said rotor shaft rotatably in said compressor;
said bearing arrangement including at least one air bearing having a bearing gap;
said at least one air bearing being configured to support said rotor shaft in said compressor with a gap and further configured to form an encircling air gap when a predetermined lift-off rotational speed of said rotor shaft is reached or overshot;
said compressor defining an air bearing flow path which opens into said bearing gap and which has an interface for fluidically connecting to a compressed-air supply;
an actuatable shut-off element arranged in said air bearing flow path between the compressed-air supply and said bearing gap and which is configured to selectively close and open said air bearing flow path;
a control unit which is signal-transmittingly connected to said electric motor for actuating said electric motor and to said shut-off element; and,
said control unit being configured to open and close the shut-off element and to actuate said electric motor in a mutually dependent manner.

2. The fuel cell system of claim 1, wherein said control unit is configured to, simultaneously with an opening of said shut-off element, actuate said electric motor in order to drive said rotor shaft when a commencement of drive is desired.

3. The fuel cell system of claim 1, wherein said control unit is configured to open said shut-off element and only subsequently actuate said electric motor in order to drive said rotor shaft, when a commencement of drive of said rotor shaft is desired.

4. The fuel cell system of claim 3, wherein said control unit is configured to actuate said electric motor only after a predetermined duration has elapsed following the opening of said shut-off element.

5. The fuel cell system of claim 3 further comprising a mass flow sensor assigned to said air bearing flow path; and said control unit being signal-transmittingly connected to said mass flow sensor and being configured to actuate said electric motor only after a predetermined quantity of compressed air has been conveyed into said bearing gap.

6. The fuel cell system of claim 3 further comprising a pressure sensor assigned to said air bearing flow path; and, said control unit being signal-transmittingly connected to said pressure sensor and being configured to actuate said electric motor only after a predetermined pressure has been reached.

7. The fuel cell system of claim 3 further comprising:
a contact sensor;
said compressor having a rotating part and a static part operatively connected to said contact sensor;
said contact sensor being configured to identify lift-off of said rotating part from said static part; and,
said control unit being signal-transmittingly connected to said contact sensor and being configured to actuate said electric motor only after said contact sensor has identified the lift-off of said rotating part.

8. The fuel cell system of claim 1, wherein said control unit is configured to close said shut-off element again, after a start of the actuation of said electric motor, only when said rotor shaft has reached or overshot said predetermined lift-off rotational speed.

9. The fuel cell system of claim 1, wherein said control unit is configured to open said shut-off element, when a stoppage of drive of said electric motor is desired, before said predetermined lift-off rotational speed is undershot.

10. The fuel cell system of claim 9, wherein said control unit is configured to close said shut-off element only when a rotational speed of said rotor shaft lies in a range below 500 rpm.

11. The fuel cell system of claim 1, wherein said air bearing is an axial bearing or a radial bearing.

12. The fuel cell system of claim 1, wherein said air bearing is an aerostatic bearing.

13. The fuel cell system of claim 12, wherein said bearing arrangement further includes at least one aerodynamic bearing.

14. The fuel cell system of claim 1, wherein said air bearing flow path is assigned a filter.

15. The fuel cell system of claim 1, wherein the vehicle is a utility vehicle.

16. The fuel cell system of claim 1, wherein said compressor is a turbo compressor.

17. A vehicle comprising:
a fuel cell system for the propulsion of the vehicle;
said fuel cell system including a compressor configured to supply air to a cathode side of a fuel cell, wherein said compressor has an electric motor, a rotor shaft operatively connected to said electric motor in order to be driven in rotation via said electric motor, and a bearing arrangement that supports said rotor shaft rotatably in said compressor;
said bearing arrangement including at least one air bearing having a bearing gap;
said at least one air bearing being configured to support said rotor shaft in said compressor with a gap and further configured to form an encircling air gap when a predetermined lift-off rotational speed of said rotor shaft is reached or overshot;
said compressor defining an air bearing flow path which opens into said bearing gap and which has an interface for fluidically connecting to a compressed-air supply;
said fuel cell system further including an actuatable shut-off element arranged in said air bearing flow path between the compressed-air supply and said bearing gap and which is configured to selectively close and open said air bearing flow path; and,
said fuel cell system further including a control unit which is signal-transmittingly connected to said electric motor for actuating said electric motor and to said shut-off element;
said control unit being configured to open and close the shut-off element and to actuate said electric motor in a mutually dependent manner;
a compressed-air supply that is configured to provide pressurized air; and,
said air bearing flow path being fluidically connected to said compressed-air supply such that pressurized air flows into said bearing gap when said shut-off element is open.

18. The vehicle of claim 17, wherein said compressed-air supply is configured to supply compressed air to multiple compressed-air circuits of the vehicle; and, said air bearing flow path is fluidically connected to one of said multiple compressed-air circuits.

19. A method for operating a fuel cell system of a vehicle, the method comprising:
transmitting a start command to a control unit when a commencement of drive is desired; and,
mutually dependently:
opening a shut-off element in an air bearing flow path of a compressor via a control unit such that pressurized air is conveyed from a compressed-air supply into a bearing gap; and,
actuating an electric motor in order to drive a rotor shaft.

20. The method of claim 19, wherein the fuel system includes a compressor configured to supply air to a cathode side of a fuel cell, wherein the compressor has an electric motor, a rotor shaft operatively connected to the electric motor in order to be driven in rotation via the electric motor, and a bearing arrangement that supports the rotor shaft rotatably in the compressor; the bearing arrangement including at least one air bearing having a bearing gap; the at least one air bearing being configured to support the rotor shaft in the compressor with a gap and further configured to form an encircling air gap when a predetermined lift-off rotational speed of the rotor shaft is reached or overshot; the compressor defining an air bearing flow path which opens into the bearing gap and which has an interface for fluidically connecting to a compressed-air supply; the fuel system further including a control unit and an actuatable shut-off element arranged in the air bearing flow path between the compressed-air supply and the bearing gap and which is configured to selectively close and open the air bearing flow path; the control unit being signal-transmittingly connected to the electric motor for actuating the electric motor and to the shut-off element; and, the control unit being configured to open and close the shut-off element and to actuate the electric motor in a mutually dependent manner.

21. The method of claim 20, wherein said actuation of the electric motor in order to drive the rotor shaft is performed via the control unit.

22. The method of claim 19, further comprising at least one of:
simultaneously actuating the electric motor in order to drive the rotor shaft and opening the shut-off element in order to convey compressed air into the bearing gap, or initially opening the shut-off element and only subsequently actuating the electric motor in order to drive the rotor shaft;
actuating the electric motor only after a predetermined duration has elapsed following the opening of the shut-off element;
detecting a mass flow conveyed through the air bearing flow path, and actuating the electric motor only after a predetermined quantity of compressed air has been conveyed into the bearing gap;
detecting a pressure prevailing in the air bearing flow path, and actuating the electric motor only after a predetermined pressure has been reached;
identifying a lift-off of a rotating part from a static part of the compressor, and actuating the electric motor only after the lift-off of the rotating part has been identified;
closing the shut-off element again, after a start of the actuation of the electric motor, only when the rotor shaft has reached or overshot a lift-off rotational speed;
opening the shut-off element, when a stoppage of drive of the electric motor is desired, before the lift-off rotational speed is undershot; and,
closing the shut-off element only when a rotational speed of the rotor shaft lies in a range below 500 rpm.

23. A control unit for a fuel cell system of a vehicle, wherein the control unit is configured to carry out the method of claim 19.

24. The control unit of claim 23, wherein the fuel system includes a compressor configured to supply air to a cathode side of a fuel cell, wherein the compressor has an electric motor, a rotor shaft operatively connected to the electric motor in order to be driven in rotation via the electric motor, and a bearing arrangement that supports the rotor shaft rotatably in the compressor; the bearing arrangement including at least one air bearing having a bearing gap; the at least one air bearing being configured to support the rotor shaft in the compressor with a gap and further configured to form an encircling air gap when a predetermined lift-off rotational speed of the rotor shaft is reached or overshot; the compressor defining an air bearing flow path which opens into the bearing gap and which has an interface for fluidically connecting to a compressed-air supply; the fuel system further including a control unit and an actuatable shut-off element arranged in the air bearing flow path between the compressed-air supply and the bearing gap and which is configured to selectively close and open the air bearing flow path; the control unit being signal-transmittingly connected to the electric motor for actuating the electric motor and to the shut-off element; and, the control unit being configured to open and close the shut-off element and to actuate the electric motor in a mutually dependent manner.

25. A computer program product comprising commands which, when executed by a computer, cause the computer to act as the control unit of claim 23.

26. A computer program product comprising program code stored on a non-transitory computer readable medium, said program code being configured, when executed by a processor, to carry out the method of claim 19.
